(19) United States
(12) Patent Application Publication
(10) Pub. No.: US 2013/0019763 A1
(43) Pub. Date: Jan. 24, 2013

(54) Chafing dish with synthetic-oil heat transference

(71) Applicant: Paul R. Scioscio, Brick, NJ (US)

(72) Inventor: Paul R. Scioscio, Brick, NJ (US)

(21) Appl. No.: 13/136,029

(22) Filed: Jul. 22, 2011

(51) Int. Cl. A23C 3/02

(52) U.S. Cl. 99/483

(57) ABSTRACT

A chafing dish assembly provides more uniform and more lasting heat to its food pan by replacing its water pan with a sealed cavity enclosing a synthetic, silicon heat transfer oil.

### CROSS-REFERENCE TO RELATED APPLICATIONS

None

### STATEMENT REGARDING FEDERALLY SPONSORED RESEARCH OR DEVELOPMENT

Research and development of this invention and application have not been federally sponsored, and no rights are given under any Federal program.

### REFERENCE TO A MICROFICHE APPENDIX

Not Applicable

### BACKGROUND OF THE INVENTION

1. Field of the Invention

This invention relates to the field of catering equipment, and, more particularly, to an improved chafing dish assembly.

2. Description of the Related Art

As is well known and appreciated, chafing dishes are widely used for buffet type food service—serving hors d'oeuvres, for example. Such chafing dishes typically include a water pan supported by a bracing structure, with a heat source to heat the water in the water pan. A food pan is supported by the water pan above the level of the water, with the expectation being that steam from the heated water will keep the food in the food pan warm. With a lid being often provided to cover the chafing dish, typically both the water pan and the food pan include outwardly extending peripheral rims. A peripheral rim of the water pan engages the bracing structure in supporting the water pan, while a peripheral rim of the food pan engages the peripheral rim of the water pan in supporting the food pan.

In most instances, flames from canister canned fuels are used as the heat source. In such arrangement; the fuel is either an alcohol base material or an oil and wick arrangement. The alcohol base material tends to vapor lock, however, so that flame size varies and uneven heat is produced. Diaphragms are sometimes then provided, adjustable in nature, to control the size of the flame and with it, hopefully, the amount of the heat produced. But, the problem continues that with the tendency of the alcohol base fuel to vaporize, the flame is often extinguished.

With the oil and wick arrangement, on the other hand, the only ability to control the temperature of the flame is by the spreading of the wick to increase the size of the flame. As a result, at best, there is very limited control of temperature using this approach.

Be these as they may, experience has shown that the warmth of the food in the food pan being heated decreases with time even if the heat source continues to provide the same amount of heat. While this might not be much of a problem for the first patrons in line at a chafing dish station, it becomes more and more apparent for those at the rear of the line—in addition to those coming back to obtain a “second-helping”. Investigation has shown that this follows from the water in the water pan being boiled away as steam through the passage of time. The end results are that not only do the top layers of the food in the food pan lose their warmth over time, but the bottom of the water pan loses its stability through distortion and degradation. The chafing dish then simply does not work as well.

### SUMMARY OF THE INVENTION

The present invention envisions a chafing dish assembly employing a synthetic, silicon heat transfer oil instead of water to heat and maintain the temperature of the food in the food pan. In accordance with the invention, a uniquely formed chafing plate replaces the water pan, into which the synthetic, silicon heat transfer oil is sealed. With the characteristics of these oils known to withstand high temperature and to remain stable with little viscosity change when heated for extended periods, the application of flame from canister canned fuels to the chafing plate then transfers the heat of the flame via the oil to the food pan. And, since the synthetic, silicon heat transfer oil does not expand, burn or break down, the heat of the chafing fuel becomes applied evenly to the food pan. While a preferred embodiment of the invention is one where the cavity is 100% completely filled with the synthetic, silicon heat transfer oil, very satisfactory results are obtained where the cavity is filled with the synthetic, silicon heat transfer oil down to 95% of the volume, with the remaining space being filled by air or vacuum.

In a preferred embodiment of the invention, the chafing plate includes three components:

a) a lower section in which a layer of aluminum is sandwiched between two layers of stainless steel;

b) a similar upper section of an aluminum layer between two layers of stainless steel; and

c) an intermediate section of the synthetic, silicon heat transfer oil between the upper and lower sections.

### BRIEF DESCRIPTION OF THE DRAWINGS

These and other features of the invention will be more clearly understood from a consideration of the following description, taken in connection with the accompanying Drawings, in which:

FIGS. 1a, 1b, 1c, 1d, 1e, 1f and 1g are helpful in understanding the synthetic, silicon oil heat transfer of the invention for a rectangular chafing dish;

FIGS. 2a, 2b, 2c, 2d, 2e, 2f and 2g are helpful in understanding the synthetic, silicon oil heat transfer of the invention for a round chafing dish; and

FIGS. 3a, 3b, 3c, 3d, 3e, 3f and 3g are helpful in understanding the synthetic, silicon oil heat transfer of the invention for an oval chafing dish.

### DETAILED DESCRIPTION OF THE INVENTION

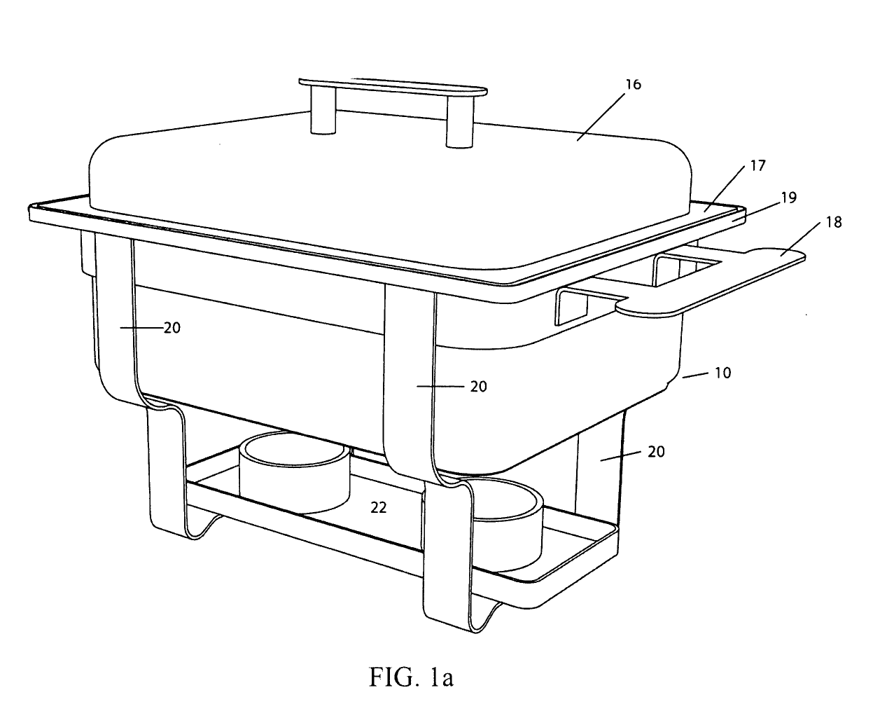

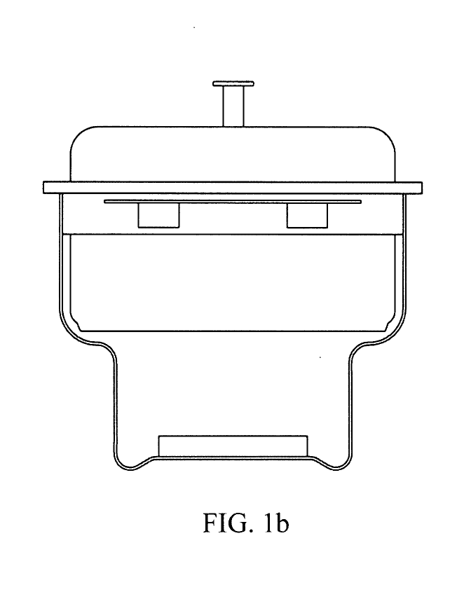

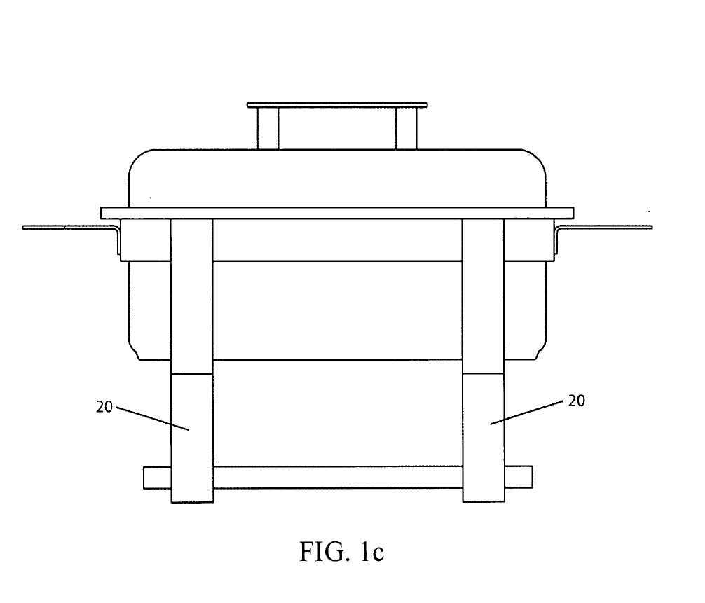

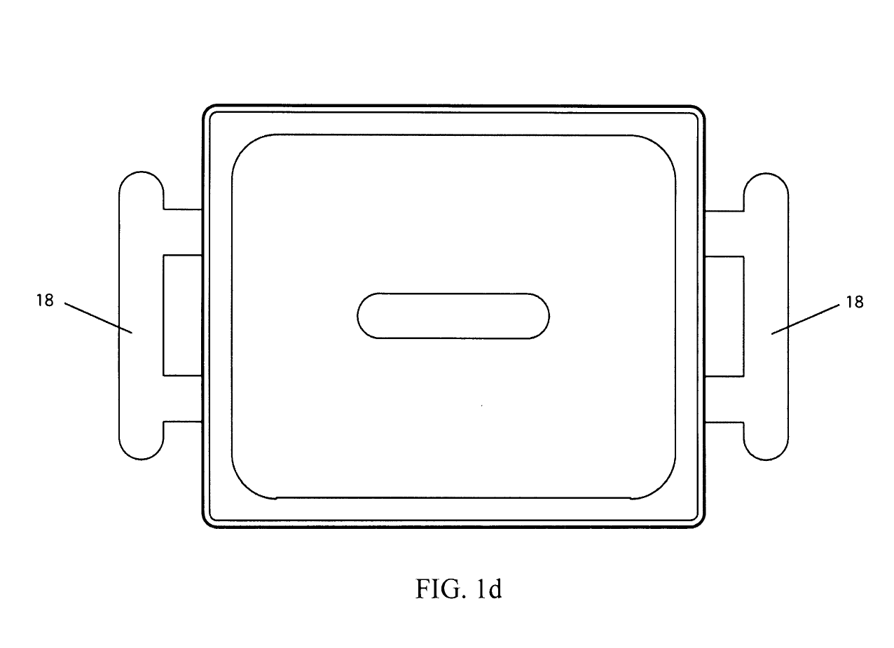

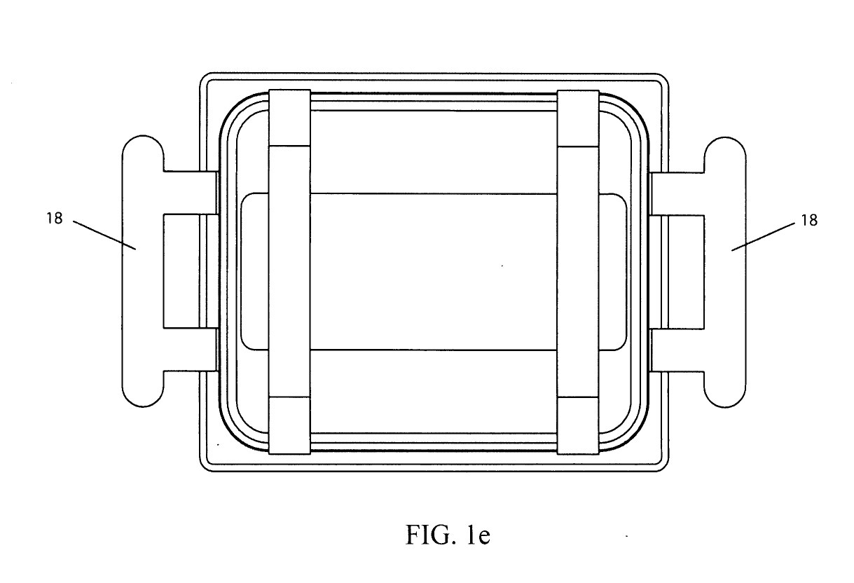

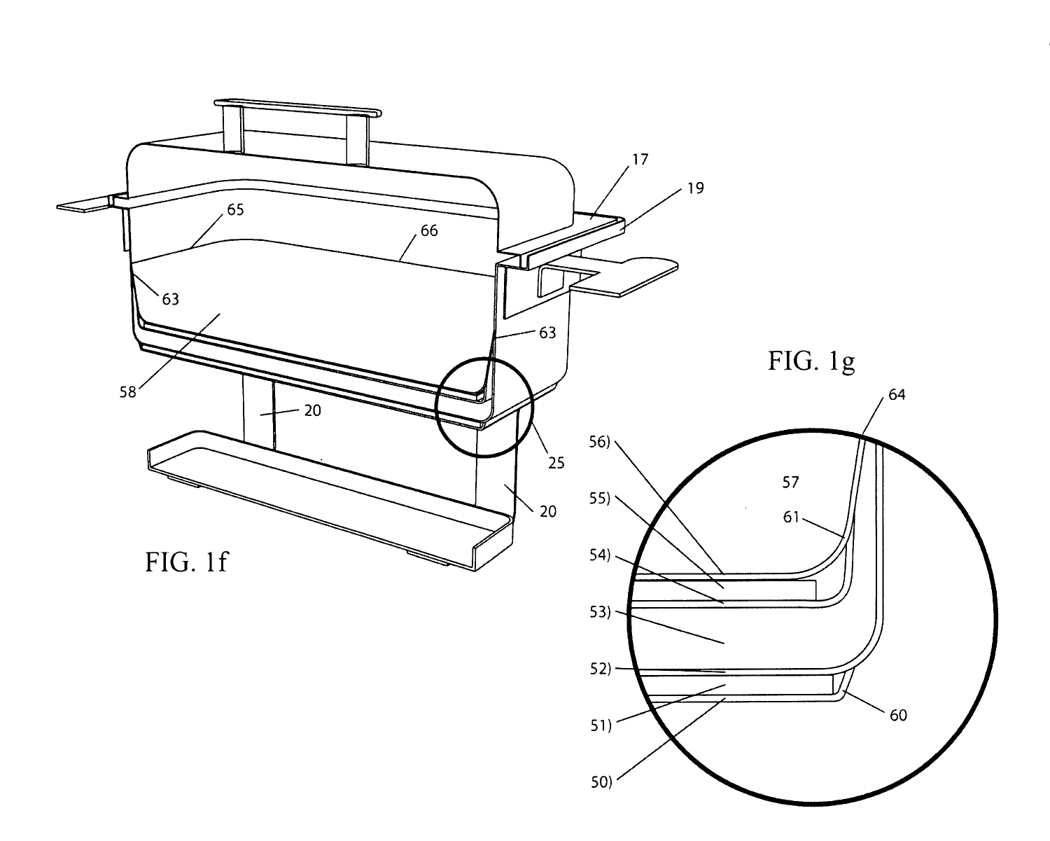

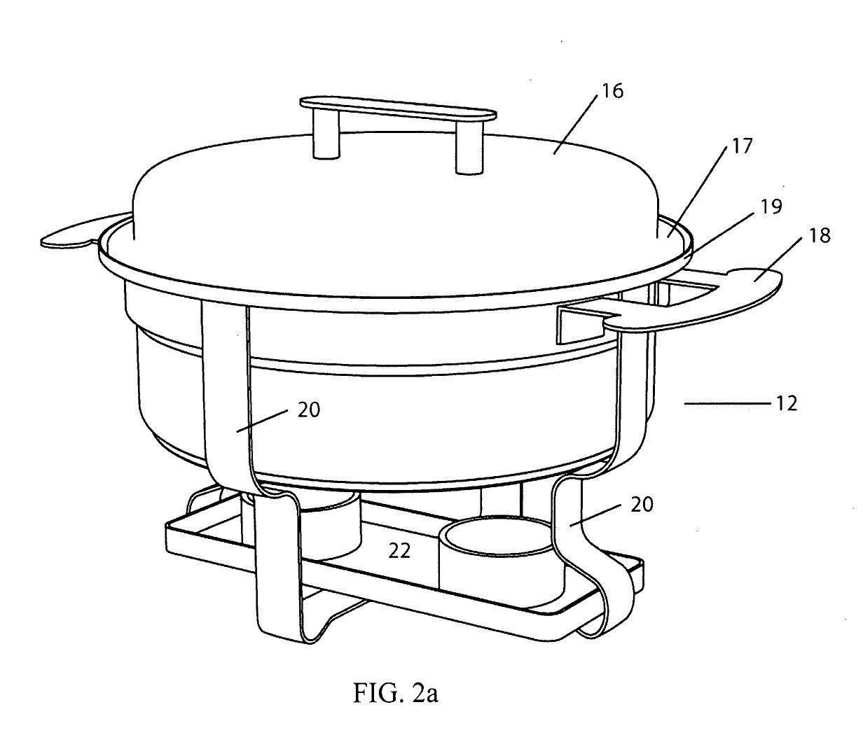

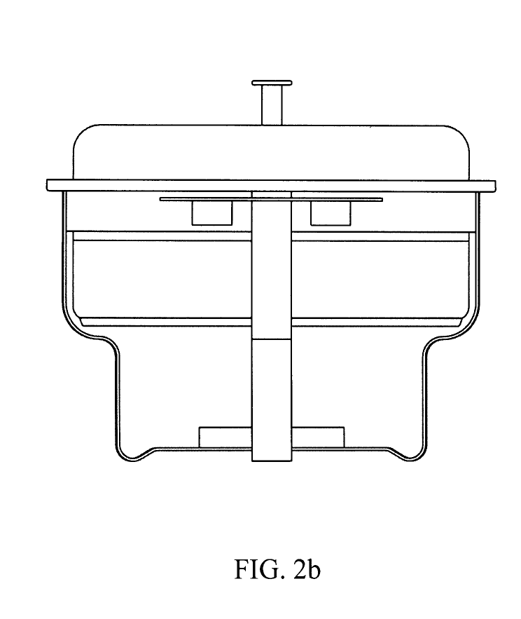

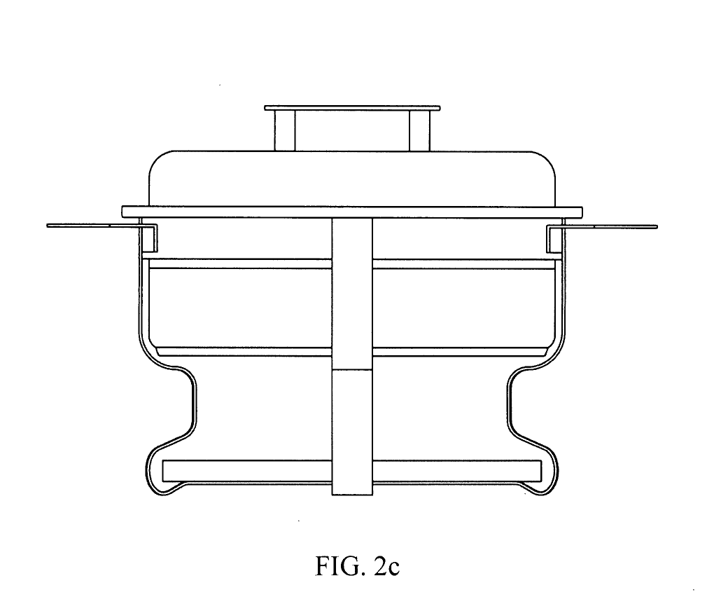

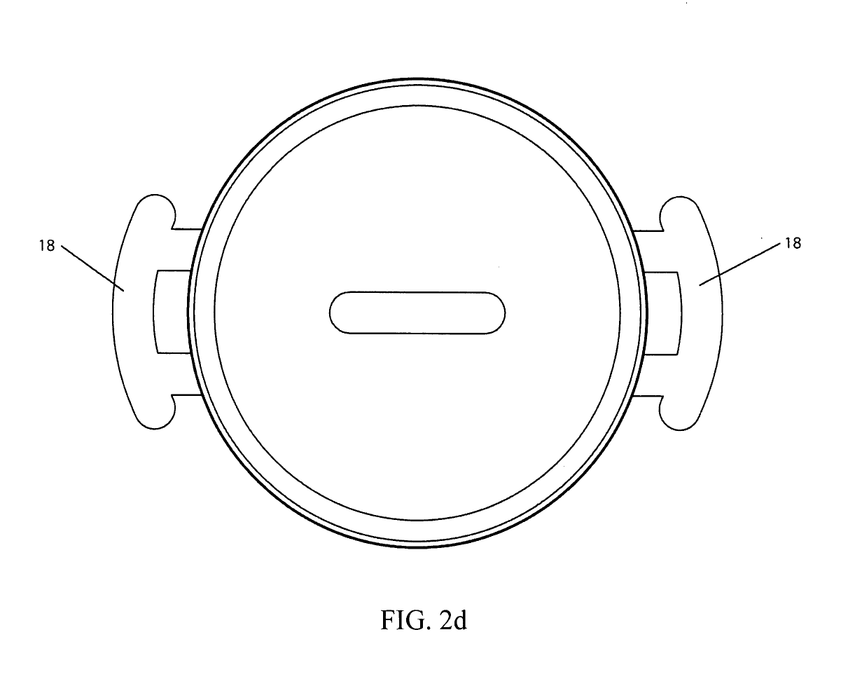

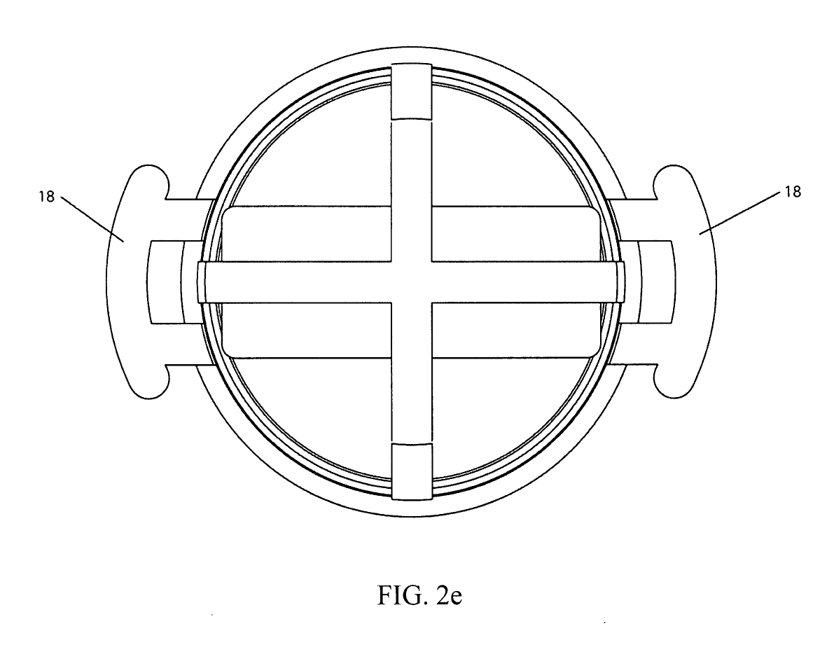

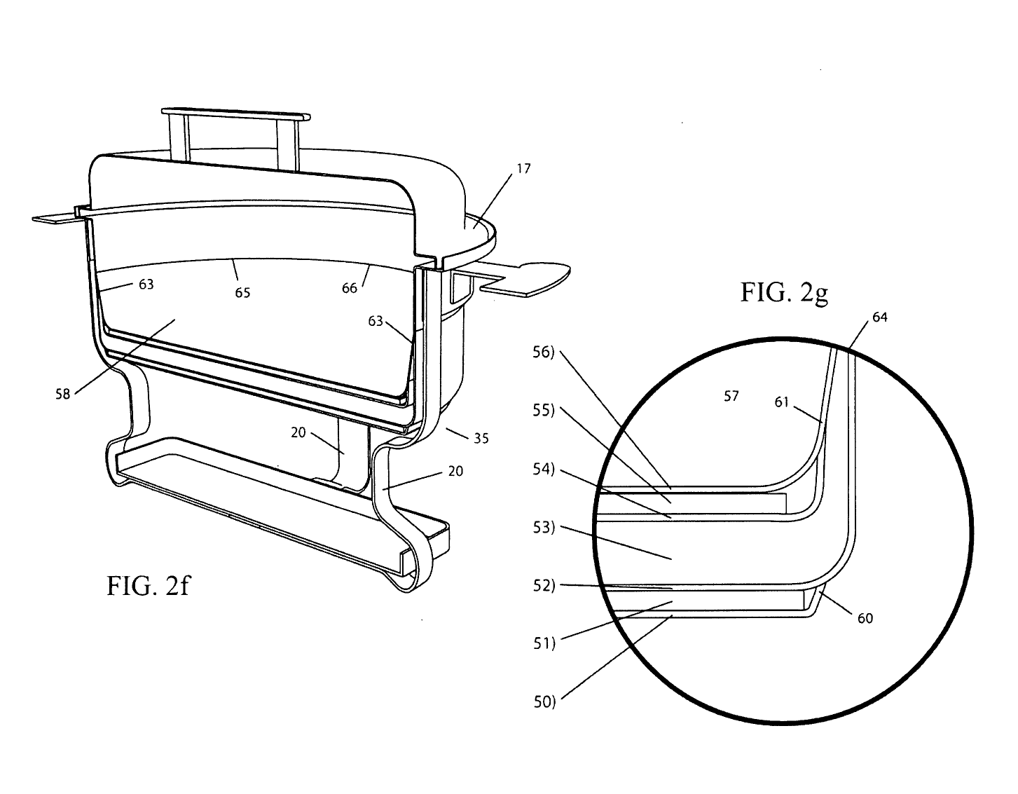

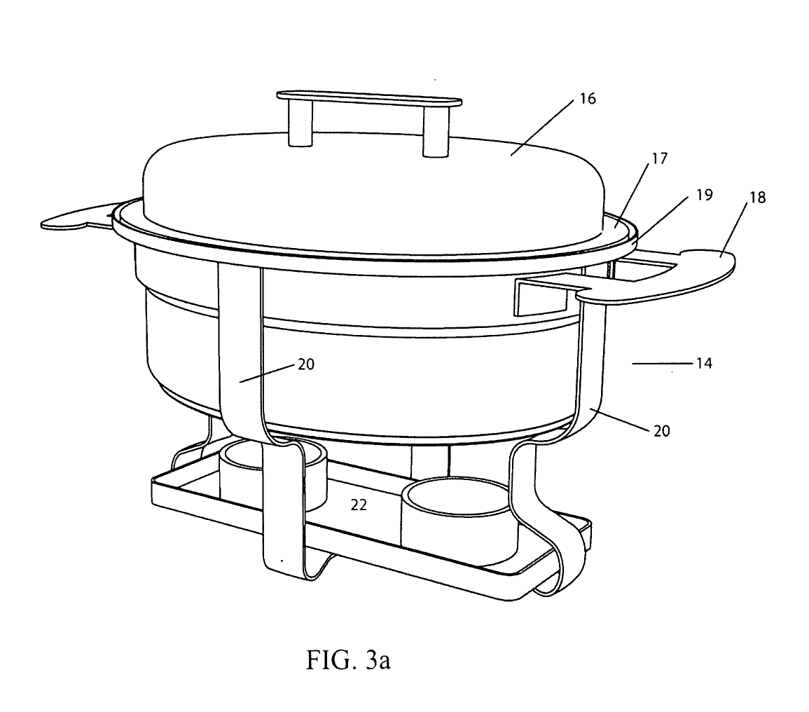

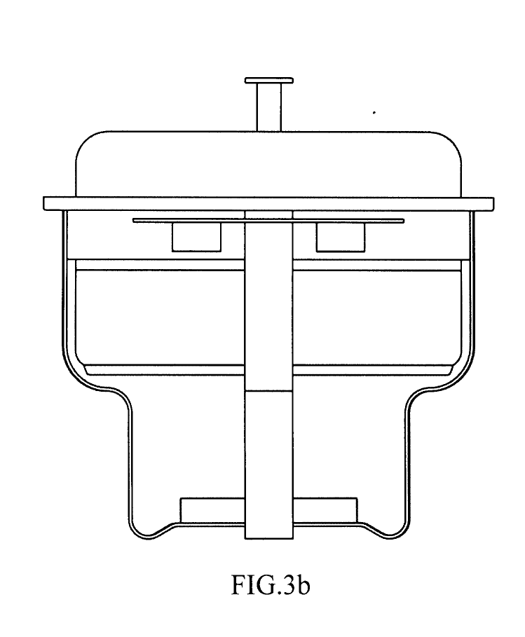

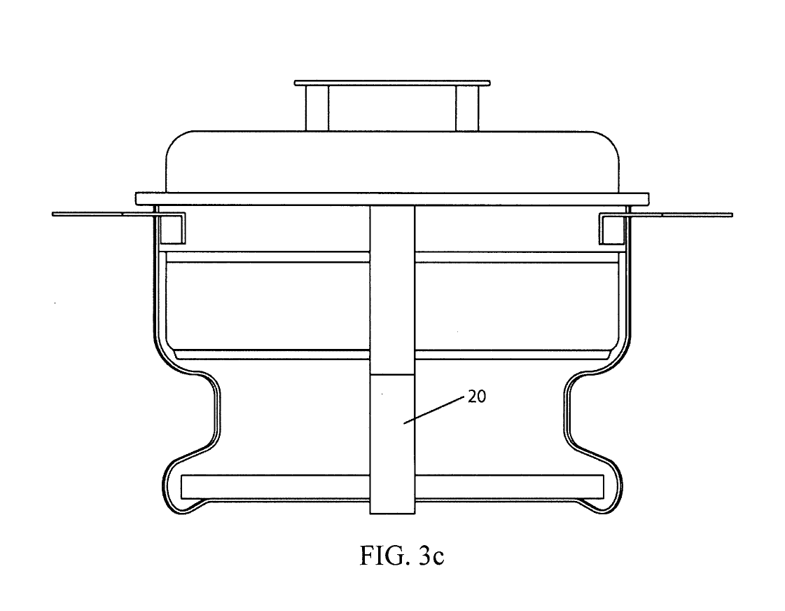

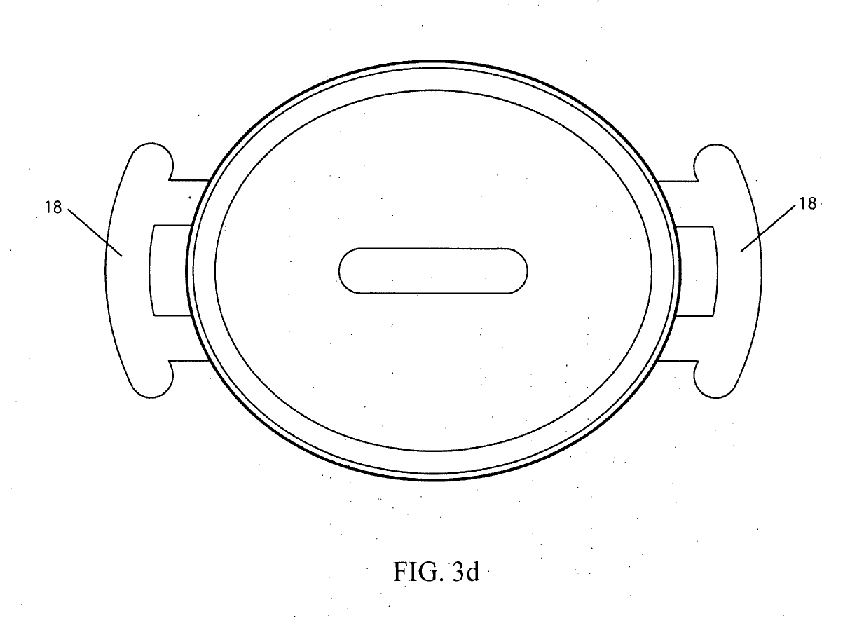

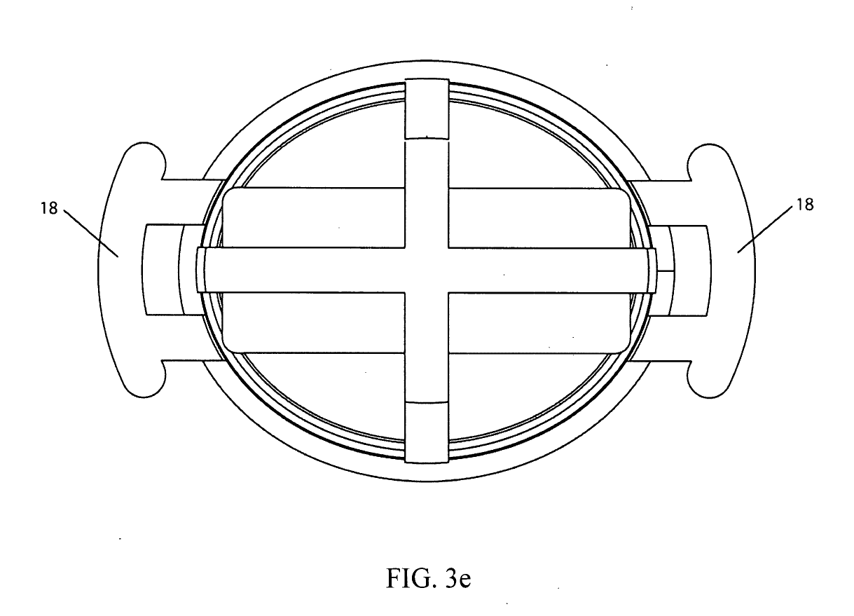

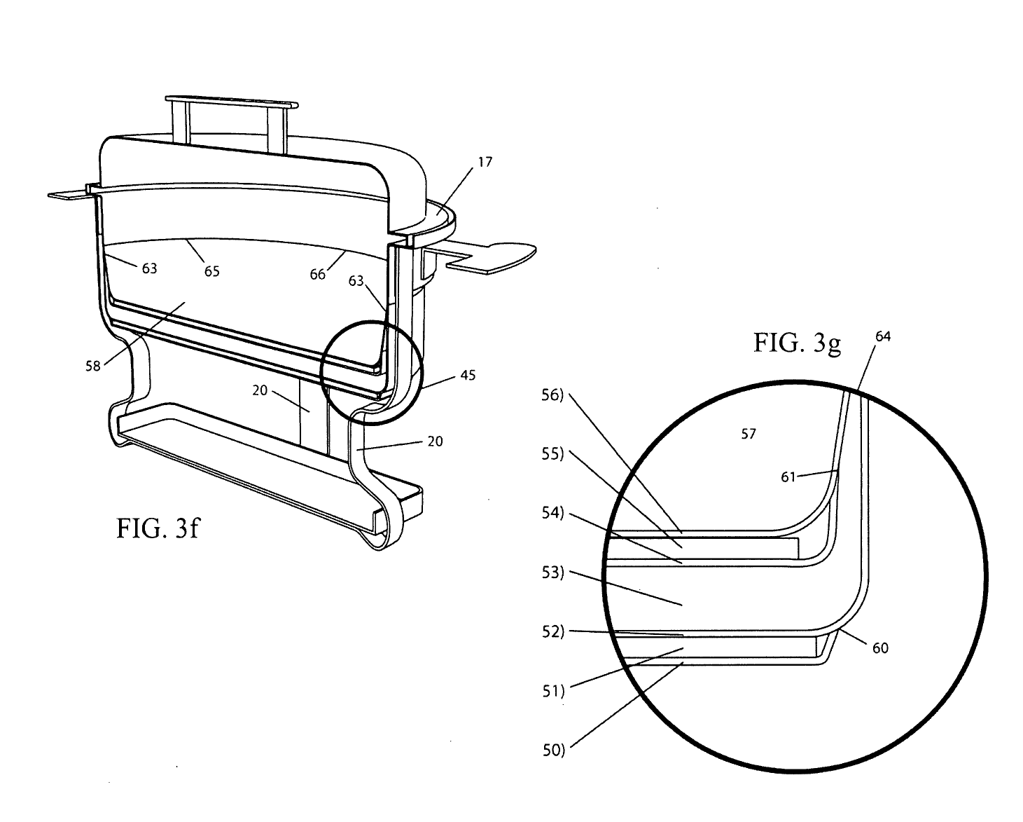

FIG. 1a is a front perspective view of a rectangular chafing dish according to the invention, FIG. 1b is a right side view (a left side view being a mirror image), FIG. 1c is a front view of the rectangular chafing dish (a back view being a mirror image), FIG. 1d is a top view of the chafing dish, FIG. 1e is a bottom view and FIGS. 1f and 1g are sectional views helpful in an understanding of the invention. FIGS. 2a-2g are corresponding views for a round chafing dish according to the invention, while FIGS. 3a-3g are further corresponding views for an oval chafing dish according to the invention.

The chafing dish is shown in FIGS. 1a, 2a and 3a at 10, 12, 14, respectively, each with a lift-off cover lid 16 which culminates in a peripheral rim 17 (FIGS. 1f, 2f 3f). A pair of oppositely positioned handles 18 assists the raising and lowering of the chafing dish into a support structure of receiving vertical struts 20. A peripheral rim 19 at the upper end of the support receives the peripheral rim 17 and a canister fuel tray 22 is included at its lower end. As will be appreciated, the contour of the peripheral rims and the specific locations of the support struts are contoured for the acceptance of its correspondingly shaped chafing dish—be it rectangular, round or oval.

FIGS. 1f and 1g are helpful in an understanding of the teachings of the invention for the rectangular chafing dish with the fuel canisters removed, and with the front half of the chafing dish cut-away from top to bottom. FIGS. 2f and 2g depict substantially the same views but for the round chafing dish, while FIGS. 3f and 3g depict the comparable views for the oval chafing dish. FIGS. 1g, 2g and 3g are substantially identical, representing blow-ups of the circular segment 25, 35, of their respective rectangular, round and oval shaped chafing dishes. In FIGS. 1g, 2g and 3g, the identifications of the following reference numerals apply in accordance with the invention:
Reference numeral 50 . . . stainless steel layer
Reference numeral 51 . . . Aluminum layer
Reference numeral 52 . . . stainless steel layer
Reference numeral 53 . . . Synthetic, silicon heat transfer oil
Reference numeral 54 . . . stainless steel layer
Reference numeral 55 . . . aluminum layer
Reference numeral 56 . . . stainless steel layer

Heat from the flame of the fuel canister applied to the bottom of the stainless steel layer 50 is transferred by the aluminum layer 51 to the stainless steel layer 52; the heat conveyed to the bottom of the stainless steel layer 52 is then transferred through the synthetic, silicon heat transfer oil 53 to the bottom of the stainless steel layer 54; from there, the heat is transferred through the aluminum layer 55 to the top stainless steel layer 56 on which the bottom of the food pan sits. As the synthetic, silicon heat transfer oil does not expand, burn or break down, the heat of the flame is applied evenly to the bottom of the food pan.

For sealing the synthetic, silicon heat transfer oil in the chafing plate (represented as 57 in each of FIGS. 1g, 2g and 3g), the stainless steel layers 50, 52, are heat stamped with the aluminum layer 51 so they melt together. The stainless steel layers 54 and 56 are also heat stamped with the aluminum layer 55 so that they likewise melt together. The point where these layers melt is indicated at 60 for the layers 50, 51 and 52, and at 61 for the layers 54, 55 and 56 (FIGS. 1g, 2g and 3g). The sealing of the synthetic, silicon heat transfer oil in the cavity 57 follows from the welding together of the stainless steel layers 52 and 56, as indicated at 63 in FIGS. 1f, 2f and 3f, and at 64 in FIGS. 1g, 2g and 3g. The welding will be understood to continue all the way about the chafing dish interior, however, as at 65 66 in FIGS. 1f, 2f and 3f.

The synthetic, silicon heat transfer oil withstands high temperatures and remains stable with little viscosity change when it is heated for extended periods of time, thereby keeping the food in the food pan of the chafing dish at a substantially constant temperature. The sandwiching of the aluminum layers between the stainless steel layers gives stability to the structure of the chafing plate 57, in addition to transferring the heat of the flame to the food pan. While a preferred embodiment of the invention is one where the layer 53 is 100% filled with the synthetic, silicon heat transfer oil, in the cavity between the stainless steel layers 52, 54, very satisfactory results are obtained where the layer 53 fills that cavity with the synthetic, silicon heat transfer oil down to some 95% of the volume. With the 100% filling of the layer 53, the synthetic, silicon heat transfer oil transfers all of the applied heat to the food pan where the heat maintenance is carried on. This allows the heat to be evenly applied, top-to-bottom and side-to-side—and, with the welding shut of the chafing plate 57, an absolute seal follows so that no leakage of oil results. The food pan of the chafing dish is placed on the top surface 58 of the layer 56 in each of FIGS. 1f, 2f and 3f.

While applicant does not wish to be limited to any particular set of values, the following have proved useful with the construction for the silicon oil heat transference of the invention:
layer 50 . . . 1.2 mm commercial grade stainless steel plate
layer 51 . . . 3.35 mm premium aluminum plate.
layer 52 . . . 1.2 mm commercial grade stainless steel plate
layer 53 . . . 4.5 mm synthetic, silicon heat transfer oil
layer 54 . . . 1.2 mm commercial grade stainless steel plate
layer 55 . . . 3.35 mm premium aluminum plate
layer 56 . . . 1.2 mm commercial grade stainless steel plate

While there have been described what are considered to be preferred embodiments of the present invention, it will be readily appreciated by those skilled in the art that modifications can be made without departing from the scope of the teachings herein. For example, whereas the invention has been described in the context of using a canister canned fuel to keep the food pan hot, the advantages which follow from the chafing plate construction apply equally as well were an electric heater to be used as the warming source—and the two should therefore be read together interchangeably. For at least such reason, therefore, resort should be had to the claims appended hereto for a true understanding of the invention.

I claim:

1. A chafing plate for transferring the heat from a canister canned fuel or electric heat source to the food pan of a chafing dish comprising:
first and second layers of stainless steel sandwiched around a first layer of aluminum;
third and fourth layers of stainless steel sandwiched around a second layer of aluminum; and
a layer of synthetic, silicon heat transfer oil between said second and third layers of stainless steel;
with said layer of synthetic, silicon heat transfer oil being sealed between said second and third layers of stainless steel.

2. The chafing plate of claim 1 wherein said first and second layers of stainless steel and said first layer of aluminum are heat stamped to melt together.

3. The chafing plate of claim 1 wherein said third and fourth layers of stainless steel and said second layer of aluminum are heat stamped to melt together.

4. The chafing plate of claim 2 wherein said third and fourth layers of stainless steel and said second layer of aluminum are heat stamped to melt together.

5. The chafing plate of claim 4 wherein said layer of synthetic, silicon heat transfer oil, said second layer of stainless steel and said fourth layer of stainless steel are welded together.

6. The chafing plate of claim 1 wherein said first layer of stainless steel is adapted for placement to absorb the heat of the canister canned fuel or electric heat source and wherein said fourth layer of stainless steel is adapted for placement to support the food pan of the chafing dish.

7. The chafing plate of claim 5 wherein said first layer of stainless steel is adapted for placement to absorb the heat of the canister canned fuel or electric heat source and wherein said fourth layer of stainless steel is adapted for placement to support the food pan of the chafing dish.

8. The chafing plate of claim 1 wherein said synthetic, silicon heat transfer oil is characterized to withstand high temperatures and to remain stable with little viscosity change when heated for extended periods.

9. The chafing plate of claim 6 wherein said synthetic, silicon heat transfer oil is characterized to withstand high temperatures and to remain stable with little viscosity change when heated for extended periods.

10. The chafing plate of claim 7 wherein said synthetic, silicon heat transfer oil is characterized to withstand high temperatures and to remain stable with little viscosity change when heated for extended periods.

11. The chafing plate of claim 1 wherein said layer of synthetic, silicon heat transfer oil fills 100% of the volume between said second and third layers of stainless steel.

12. The chafing plate of claim 6 wherein said layer of synthetic, silicon heat transfer oil fills 100% of the volume between said second and third layers of stainless steel.

13. The chafing plate of claim 7 wherein said layer of synthetic, silicon heat transfer oil fills 100% of the volume between said second and third layers of stainless steel.
